(19) United States
(12) Patent Application Publication
(10) Pub. No.: US 2020/0076864 A1
(43) Pub. Date: Mar. 5, 2020

(54) METHOD FOR OPERATING A COLLABORATION AND COMMUNICATION PLATFORM, AND COLLABORATION AND COMMUNICATION PLATFORM

(71) Applicant: Unify Patente GmbH & Co. KG, Munchen (DE)

(72) Inventor: Urich Schmitz, Wurselen (DE)

(21) Appl. No.: 16/467,664

(22) PCT Filed: Dec. 20, 2017
(86) PCT No.: PCT/EP2017/083956

§ 371 Date: Jun. 7, 2019

(30) Foreign Application Priority Data
Dec. 22, 2016 (DE) 10 2016 125 345.6

(51) Int. Cl. H04L 29/06; H04L 29/08

(52) U.S. Cl. CPC H04L 65/4038; H04L 65/608; H04L 67/1097; H04L 63/0876; H04L 65/1006; H04L 65/1069; H04L 67/02

(57) ABSTRACT

The invention relates to a method for operating a collaboration and communication platform having a web-RTC-based cloud service, which is operated by a first network system provided in a first cloud, having at least one access node ACC, at least one application node, at least one media access control node MAC, and at least one storage node. The method comprises the following steps: providing at least one second MAC node for a second network system of a service provider, which is connected to the first network system via a secure link, in particular an HTTPS link, wherein all the RTC and media services provided by the service provider are executed via the second MAC node, and wherein all user-sensitive data of the service provider of the second network system are stored in the at least one storage node of the first network system. The invention further relates to a collaboration and communication platform configured to carry out the method according to the invention.

### FIELD OF INVENTION

The invention concerns a method for operating a collaboration and communication platform, as well as a corresponding collaboration and communication platform.

### BACKGROUND OF THE INVENTION

In the prior art, cloud-based collaboration and communication platforms are known, for communication and cooperation by teams in companies, for example, on which users can hold real-time conferences, among other things. In order to enable interactive audio and video streaming, as well as desk sharing, these types of collaboration and communication platforms generally use media access control (MAC) nodes (media hubs), through which a large portion of the real-time/media data traffic is routed. Because MAC nodes support both web real-time communication (WebRTC) and the Session Initiation Protocol (SIP), the data traffic routed through them is extremely high, and so-called hotspots are generated in the network with respect to bandwidth use.

In addition, bandwidth on the public Internet is generally more expensive than on an internally operated Intranet, for example. This means that the portion of internally operated Intranet communications is normally greater than the portion from one network domain to another network domain via the public Internet, for example.

It is therefore especially important for large company network operators, who use the aforementioned cloud solutions, or for telecommunication providers, who resell the cloud solutions, to use their own traffic networks and/or data centers as much as possible for this type of data traffic, in particular audio and/or video streaming and/or desk sharing, in order to work cost-efficiently.

### SUMMARY OF THE INVENTION

The objective of the present invention is therefore to offer a method for operating a collaboration and communication platform, as well as a corresponding collaboration and communication platform, with which data traffic via the Internet and the related costs can be reduced.

The invention achieves this objective by means of a method for operating a collaboration and communication platform as well as a collaboration and communication platform with the features as in the claims. The invention offers a method for operating a collaboration and communication platform with a WebRTC-based cloud service, which is operated through a first network system provided in a first cloud with at least one access (ACC) node, one application (APP) node, one first media access control (MAC) node, and at least one storage node, wherein the method includes the following steps: Provision of a second MAC node for a second network system belonging to a service provider, which is connected to the first network system via an HTTPS (Hypertext Transfer Protocol Secure) link, wherein all RTC and media services supplied by the service provider are executed via the second MAC node, and wherein all user-sensitive data in the possession of the service provider supplying the second network system is stored in the at least one storage node in the first network system. With the method configuration according to the invention, it is possible to reduce bandwidth costs or advantageously decrease data traffic via the Internet, because it allows Internet data traffic to be moved to internal network systems from service providers that are more cost-effective for data traffic. According to the invention, the service provider provides a proprietary second MAC node for this, via which real-time audio and/or video as well as shared desktop streams can be routed. The service provider operating this second MAC node in his own network can thereby offer its customers telecommunication services directly from its own network outward, so that all of the services it offers and the data streams related to them do not have to run first through the central first MAC node of the communication and collaboration platform. Data traffic through the MAC nodes of the communication and collaboration platform can thereby be significantly reduced. Because the second WebRTC (MAC) node is hosted in the service provider's data center, costs can be considerably lower. The solution according to the invention, which is configured such that the communication and collaboration platform hosts and operates all SaaS (Software as a Service) components while the service provider hosts and operates all PaaS (Platform as a Service) components for the MAC nodes (WebRTC and media), is advantageous for both the provider or operator of the communication and collaboration platform and the service provider using that platform. A high-level architecture with the above-described advantages is therefore possible using the method according to the invention.

In one preferred embodiment, the second network system is a data center belonging to the service provider.

In another preferred embodiment, the second MAC node is hosted and operated through the service provider's data center.

The RTC and media services supplied by the service provider are preferably SIP- and WebRTC-based real-time audio and/or video and/or shared desktop streams. It is also preferred for the second MAC node to be a WebRTC media hub for bidirectional real-time audio and/or video streams and/or shared desktop environments.

In still another preferred embodiment, media services and RTC services are provided on the collaboration and communication platform, in particular for setting up real-time conferences for audio and/or video desktops.

Preferably, the service provider supplying the second network system also provides the media services and RTC services for the collaboration and communication platform.

In addition, it is advantageous for the second MAC node to be authenticated and authorized before it is registered on the first network system, so that security aspects are adequately addressed.

Preferably, the second MAC node is connected to the access node of the first network system through a secure link.

The second MAC node can be connected to the first MAC node through the access nodes and the at least one APP node from the first network system.

In addition, according to the invention a collaboration and communication platform with a WebRTC-based cloud service is provided, which can be operated through a first network system supplied in a first cloud and having at least one access (ACC) node, one application (APP) node, one first media access control (MAC) node, and at least one storage node, including: at least one second MAC node for a second network system belonging to a service provider, which can be connected to the first network system via a secure link, in particular an HTTPS link, wherein the second MAC node is configured so that all RTC and media services supplied by the service provider are executed through it, and wherein the at least one storage node is configured so that all user-sensitive data in the possession of the service provider supplying the second network system is stored in the first network system. When the above-described method is executed, the collaboration and communication platform is configured so that it offers the above-described advantages.

Additional features, tasks, advantages and details of the present invention will become more apparent from the following description of specific exemplary embodiments and their representation in drawings in the included figures. It is understood that features, tasks, advantages and details of individual exemplary embodiments are transferable to other exemplary embodiments and are considered to be disclosed also in connection with the other exemplary embodiments unless this is obviously inapplicable for technical or physical reasons. Accordingly, features of various exemplary embodiments can fundamentally be combined with other exemplary embodiments and the combination can also be considered an exemplary embodiment of the invention.

The invention is described below in more detail based on preferred exemplary embodiments and with reference to the FIGURE.

### BRIEF DESCRIPTION OF THE DRAWING

FIG. 1 schematically shows one implementation of the high-level architecture of a communication and collaboration platform according to one embodiment of the invention.

### DESCRIPTION OF THE PREFERRED EMBODIMENTS

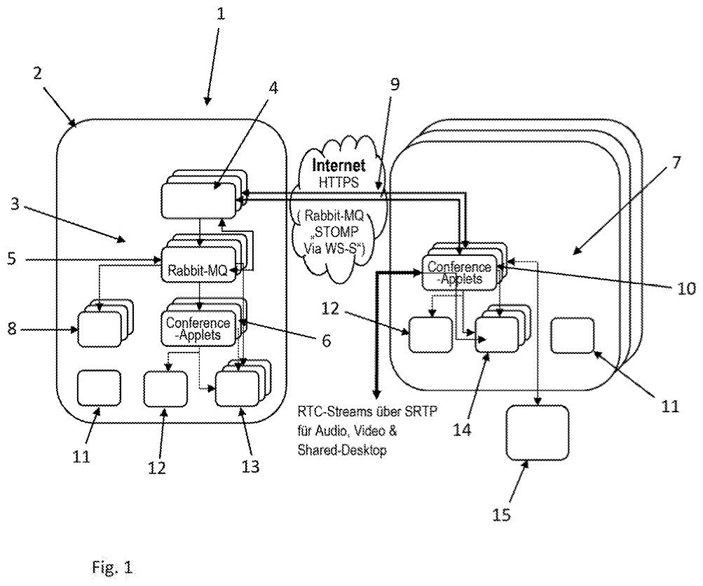

FIG. 1 schematically shows a communication and collaboration platform 1 with a WebRTC-based cloud service according to one embodiment of the invention. In the embodiment shown here, the WebRTC-based cloud service is operated through a first data center or first network system 3 operated in a first cloud 2. The first network system 3 includes several types of nodes. However, the important nodes are the access (ACC) node 4, the application (APP) node 5, and the first media access control (MAC) node 6. Additional node types are MGMT nodes 11 (MGTM is a management application), OPER nodes 12 (OPER indicates operational nodes, including user interfaces), and central ZOO nodes 13 (ZOO indicates a central registration unit; here nodes and services are signed in, with their configuration data). The central ZOO nodes 13 are operated correspondingly as remote ZOO nodes 14 in the second network system 7 described below in more detail.

In this configuration, all node types are supplied within the same data center and operated by the same operator/provider. The MAC node 6 is appropriate for all bidirectional real-time audio and/or video and/or shared desktop streams and provides WebRTC standard or SIP-based support for them.

In order to reduce the data traffic running through the first MAC node 6, a second MAC node 10 is provided in a data center in a second network system 7, which is connected to the SIP Private Branch Exchange (PBX) or an SIP trunk or IMS system of the service provider and is designated generally in the FIGURE with the reference 15. It can be a data center supplied by a public telecommunication service provider or similar entity, but it can also be a private data center belonging to a company or organization. The supply of the second MAC node 10 for a network external to the communication and collaboration platform 1 (here, the second network system 7) through the communication and collaboration platform 1 is designated as a local or remote (GEO) separated MAC model. This allows not only the second MAC node 10 but also all use and implementation instructions to be delivered to the operator of the data center on the second network 7.

It is also important that all user-sensitive data (conversations, user data, etc.) is then stored in the storage node 8 in the first cloud 2 of the communication and collaboration platform 1 and not also stored externally. The service provider of the data center for the second network system 7 has no access to that data. It is not responsible for data storage, except for data storage with respect to MAC configuration data and RTC statistical/backtracking data. However, it is responsible for all SIP- and WebRTC-based real-time audio, video, and/or shared desktop streams. This generates a clear division of work that is advantageous for both sides, as already explained.

The connection through the link 9 between the first network system 2 and the second network system 7 is a secure HTTPS connection. “Outside,” i.e., locally separated from the first cloud 2, second MACs 10 must be authenticated and authorized before they can be registered. The link 9 between the second MAC 10 and the first cloud 2 processes primarily session and signaling details (such as “create RTC session,” “add/remove/change parties with RTC session,” etc.). With the configuration shown here, the network data traffic between the first cloud 2 and the second MAC 10 can be much lower than the RTC stream data traffic via the Secure Realtime Transport Protocol (SRTP).

For example, operators of outside GEO-MACs register from 1 to N “tenants” corresponding to the second MAC 10 in the first cloud 2, shown and described here as an example. All RTC sessions for these tenants are activated on the outside second MAC 10 (GEO-MAC) instead of in the first cloud 2. An advantage to this is that, if the outside second MACs 10 are not operating (for maintenance reasons or during updates, for example), the first cloud 2 can also use the local second MACs 10 as backup. A further advantage is that it gives operators of data centers on the second or additional networks 7 the ability to offer and sell user accounts or other application services to their tenants and manage them directly, resulting in additional cost savings.

The above-described and other aspects provided by the communication and collaboration platform are listed and summarized below. Second MAC nodes 10 that are locally/remotely separated from the first cloud 2 are geographically distributed and geographically separated by the application node 5, which hosts the business logic primarily related to signaling and content distribution. Remotely/locally separated second MAC nodes 2 must be authenticated and authorized before they can sign on. This also allows, for example, share-related user licenses between the provider/operator of the communication and collaboration platform 1, operating the real-time collaboration application, and the telecommunication provider, operating the second MAC node 10. On the other hand, separate MAC licenses per registered node can also be issued, or licenses per registered MAC node service or feature, such as capturing, transcription, SIP- and/or Codec cooperation. In addition, sessions or transactions that are payable or billable on a per-use basis can be executed. It also allows for SLA-based fallback solutions in the event that the first MAC node 6 of the first cloud 1 fails and also the possibility that operators can provide SLA-based separate MAC nodes per tenant. The node structure or distribution required for all of these concepts is provided by the invention.

1. A method for operating a collaboration and communication platform with a WebRTC-based cloud service, which is operated through a first network system provided in a first cloud with at least one access (ACC) node, at least one application (APP) node, at least one first media access control (MAC) node, and at least one storage node, wherein the method comprises:
providing at least one second MAC node for a second network system belonging to a service provider, which is connected to the first network system via a secure link, in particular an HTTPS link, wherein all RTC and media services supplied by the service provider are executed via the second MAC node, and wherein all user-sensitive data in the possession of the service provider supplying the second network system is stored in the at least one storage node in the first network system.

2. The method as in claim 1, wherein the second network system is a data center belonging to the service provider.

3. The method as in claim 2, wherein the second MAC node is hosted and operated through the service provider's data center.

4. The method as in claim 1, wherein the RTC and media services supplied by the service provider are at least one of SIP- and WebRTC-based real-time audio, video and shared desktop streams, and wherein the second MAC node is a WebRTC media hub for bidirectional real-time audio and/or video and/or shared desktop streams.

5. The method as in claim 1, wherein media services and RTC services used for setting up real-time conferences for audio and/or video desktops are provided on the collaboration and communication platform.

6. The method as in claim 1, wherein the service provider supplying the second network system provides the media services and RTC services for the collaboration and communication platform.

7. The method as in claim 1, wherein the second MAC node is authenticated and authorized before the second MAC node is registered in the first network system.

8. The method as in claim 1, wherein the second MAC node is connected to the access node of the first network system.

9. The method as in claim 8, wherein the second MAC node is connected to the first MAC node through the access node and the at least one application node of the first network system.

10. A collaboration and communication platform for a WebRTC-based cloud service, comprising a first network system provided in a first cloud with at least one access (ACC) node, at least one application (APP) node, at least one first media access control (MAC) node, and at least one storage node, comprising;
at least one second MAC node for a second network system belonging to a service provider, which can be connected to the first network system via a secure link, wherein the second MAC node is configured so that all RTC and media services supplied by the service provider are executed through the second MAC node and wherein the at least one storage node is configured such that all user-sensitive data in the possession of the service provider supplying the second network system is stored in the first network system.

11. The collaboration and communication platform of claim 10 wherein the secure link is an HTTPS link.
